(19) United States
(12) Patent Application Publication
(10) Pub. No.: US 2013/0309635 A1
(43) Pub. Date: Nov. 21, 2013

(54) METHODS FOR MEASURING CHILD-LIKING AND PREFERENCE FOR PRE-SCHOOL-AGED CHILDREN

(71) Applicant: NESTEC S.A., Vevey (CH)

(72) Inventors: Lotika SAVANT, Norton Shores, MI (US); Mary Michele FOLEY, Whitehall, MI (US)

(73) Assignee: Nestec S.A., Vevey (CH)

(21) Appl. No.: 13/874,014

(22) Filed: Apr. 30, 2013

Related U.S. Application Data
(60) Provisional application No. 61/647,089, filed on May 15, 2012.

(51) Int. Cl. G09B 19/00

(52) U.S. Cl. CPC G09B 19/0092
USPC 434/127

(57) ABSTRACT

The present disclosure provides methods for obtaining direct child-liking information in a product testing environment and/or for improving development of products for pre-school-aged consumers. In an embodiment, methods for directly assessing child-liking of a food product are provided and include the use of a 4-point, bifurcated scale-based approach. The scale-based approach employs an initial two-component assessment as to whether a child finds a product to be acceptable or unacceptable. Upon establishment of the acceptableness of the food product, the scale-based approach further asks the child whether the acceptableness of the food product should be modified to assess the degree of acceptableness of the food product.

### BACKGROUND

The present disclosure relates generally to health and nutrition. More specifically, the present disclosure relates to methods for obtaining direct child-liking scores among pre-school-aged children in product testing environments and/or for product development.

Historically, acceptance (e.g., like/dislike) of consumable products by children to guide product development for child-targeted products in a product testing context has been obtained from parents via scale-based responses such as a child-liking scores based on a subjective interpretation of the child's responses to products. Child-liking, as historically assessed by parents, however, does not provide stable results due to the interaction and influence of parents on their children's responses. As a result, decisions to guide product development are heavily influenced by adult preferences.

Other behavioral observation techniques such as, for example, facial coding by expert observers to interpret child-liking during product development testing are also available, but are typically applied in a more academic setting and the results are cumbersome to collect and utilize to guide product development in the fast-paced product testing environment of the consumer goods industry. As such, there exists a need to provide methods for obtaining direct child-liking scores along pre-school-aged children in a product testing environment.

### SUMMARY

Methods for evaluating child-liking and preferences for food products are provided. In an embodiment, a method for assessing child-liking of a food product is provided. The method includes providing a food product to a child, instructing the child to consume the food product, asking the child, after the child consumes the food product, to classify the food product using either a positive descriptor or a negative descriptor, asking the child, if the child classified the food product using a positive descriptor, to further classify the food product using the positive descriptor or a modified positive descriptor, and asking the child, if the child classified the food product using a negative descriptor, to further classify the food product using the negative descriptor or a modified negative descriptor.

In another embodiment, a method for improving product development is provided. The method includes providing a food product to a child, instructing the child to consume the food product, asking the child, after the child consumes the food product, to classify the food product using either a positive descriptor or a negative descriptor, asking the child, if the child classified the food product using a positive descriptor, to further classify the food product using the positive descriptor or a modified positive descriptor, and asking the child, if the child classified the food product using a negative descriptor, to further classify the food product using the negative descriptor or a modified negative descriptor.

In an embodiment, the child is a pre-school-aged child. The child be from about 24 months to about 42 months of age.

In an embodiment, the food product is formulated for consumption by a child.

In an embodiment, the method further includes recording the classifications provided by the child. The classifications may be recorded by a means selected from the group consisting of a written questionnaire, a processing device, or combinations thereof.

In an embodiment, the method further includes showing the child pictures of a variety of foods and asking the child to identify each of the foods in the pictures with a positive or negative indicator.

In an embodiment, the method further includes showing the child a picture of the food product next to a picture of a second food product, placing the first food product in front of the child, and asking the child to point to the picture of the first food product.

In an embodiment, the method further includes showing the child a picture of the food product next to a picture of a second food product, placing the second food product in front of the child, and asking the child to point to the picture of the second food product.

In an embodiment, the method further includes providing a second food product to a child. The child may then be instructed to consume the second food product. After consumption of the second food product, the child may be asked to classify the second food product using either a positive descriptor or a negative descriptor. If the child classified the second food product using a positive descriptor, the child may be asked to further classify the food product using the positive descriptor or a modified positive descriptor. If the child classified the second food product using a negative descriptor, the child may be asked to further classify the food product using the negative descriptor or a modified negative descriptor.

In an embodiment, the positive descriptor comprises a positive descriptor commonly associated with children of an age ranging from about 24 months to about 42 months. The positive descriptor may be selected from the group consisting of yummy, good, tasty, delicious, scrumptious, or combinations thereof. In an embodiment, the positive descriptor is yummy.

In an embodiment, the negative descriptor comprises a negative descriptor commonly associated with children of an age ranging from about 24 months to about 42 months. The negative descriptor may be selected from the group consisting of yucky, bad, icky, gross, or combinations thereof. In an embodiment, the negative descriptor is yucky.

In an embodiment, the modified positive descriptor comprises the positive descriptor and a modifier, the modifier commonly associated with children of an age ranging from about 24 months to about 42 months. The modifier may be selected from the group consisting of super, extra, really, more, very, or combinations thereof. In an embodiment, the modifier is super.

In an embodiment, the modified negative descriptor comprises the negative descriptor and a modifier, the modifier commonly associated with children of an age ranging from about 24 months to about 42 months. The modifier may be selected from the group consisting of super, extra, really, more, very, or combinations thereof. In an embodiment, the modifier is super.

In yet another embodiment, a method for improving product development is provided. The method includes providing a food product to a child, instructing the child to consume the food product, instructing the child, after the child consumes the food product, to classify the food product using either a positive descriptor or a negative descriptor, instructing the child, if the child classified the food product using a positive descriptor, to further classify the food product using the positive descriptor or a modified positive descriptor, and instructing the child, if the child classified the food product using a negative descriptor, to further classify the food product using the negative descriptor or a modified negative descriptor.

In still yet another embodiment, a method for developing a new consumable product is provided. The method includes providing a food product to a child, instructing the child to consume the food product, instructing the child, after the child consumes the food product, to classify the food product using either a positive descriptor or a negative descriptor, instructing the child, if the child classified the food product using a positive descriptor, to further classify the food product using the positive descriptor or a modified positive descriptor, and instructing the child, if the child classified the food product using a negative descriptor, to further classify the food product using the negative descriptor or a modified negative descriptor.

In another embodiment, a method for improving marketing of a consumable product is provided. The method includes providing a food product to a child, instructing the child to consume the food product, instructing the child, after the child consumes the food product, to classify the food product using either a positive descriptor or a negative descriptor, instructing the child, if the child classified the food product using a positive descriptor, to further classify the food product using the positive descriptor or a modified positive descriptor, and instructing the child, if the child classified the food product using a negative descriptor, to further classify the food product using the negative descriptor or a modified negative descriptor.

In yet another embodiment, a method for predicting market success of a food product is provided. The method includes providing a food product to a child, instructing the child to consume the food product, instructing the child, after the child consumes the food product, to classify the food product using either a positive descriptor or a negative descriptor, instructing the child, if the child classified the food product using a positive descriptor, to further classify the food product using the positive descriptor or a modified positive descriptor, and instructing the child, if the child classified the food product using a negative descriptor, to further classify the food product using the negative descriptor or a modified negative descriptor.

In an embodiment, the child is a pre-school-aged child. The child may be from about 24 months to about 42 months of age.

In an embodiment, the food product is formulated for consumption by a child.

In an embodiment, the method further includes recording the classifications provided by the child. The classifications may be recorded by a means selected from the group consisting of a written questionnaire, a processing device, or combinations thereof.

In an embodiment, the method further includes showing the child pictures of a variety of foods and instructing the child to identify each of the foods in the pictures with a positive or negative indicator.

In an embodiment, the method further includes showing the child a picture of the food product next to a picture of a second food product, placing the first food product in front of the child, and instructing the child to point to the picture of the first food product.

In an embodiment, the method further includes showing the child a picture of the food product next to a picture of a second food product, placing the second food product in front of the child, and instructing the child to point to the picture of the second food product.

In an embodiment, the method further includes providing a second food product to a child and instructing the child to consume the second food product. After consumption, the child may be instructed to classify the second food product using either a positive descriptor or a negative descriptor. If the child classified the second food product using a positive descriptor, the child may be instructed to further classify the food product using the positive descriptor or a modified positive descriptor. If the child classified the second food product using a negative descriptor, the child may be instructed to further classify the food product using the negative descriptor or a modified negative descriptor.

In an embodiment, the positive descriptor comprises a positive descriptor commonly associated with children of an age ranging from about 24 months to about 42 months. The positive descriptor may be selected from the group consisting of yummy, good, tasty, delicious, scrumptious, or combinations thereof. In an embodiment, the positive descriptor is yummy.

In an embodiment, the negative descriptor comprises a negative descriptor commonly associated with children of an age ranging from about 24 months to about 42 months. The negative descriptor may be selected from the group consisting of yucky, bad, icky, gross, or combinations thereof. In an embodiment, the negative descriptor is yucky.

In an embodiment, the modified positive descriptor comprises the positive descriptor and a modifier, the modifier commonly associated with children of an age ranging from about 24 months to about 42 months. The modifier may be selected from the group consisting of super, extra, really, more, very, or combinations thereof. In an embodiment, the modifier is super.

In an embodiment, the modified negative descriptor comprises the negative descriptor and a modifier, the modifier commonly associated with children of an age ranging from about 24 months to about 42 months. The modifier may be selected from the group consisting of super, extra, really, more, very, or combinations thereof. In an embodiment, the modifier is super.

An advantage of the present disclosure is to provide methods for obtaining direct child-liking scores in a product testing environment.

Another advantage of the present disclosure is to provide methods for improving product development.

Yet another advantage of the present disclosure is to provide methods for differentiating child-liking and preference among pre-school-aged children in a product testing environment.

Still yet another advantage of the present disclosure is to provide methods for determining product preferences by pre-school-aged children during product testing.

Another advantage of the present disclosure is to provide methods for monitoring child acceptance of a food product.

Still yet another advantage is to provide methods for predicting the marketing success of a food product.

Additional features and advantages are described herein, and will be apparent from the following Detailed Description.

### DETAILED DESCRIPTION

As used herein, a “9-Point Hedonic Scale” refers to the 9-Point Hedonic Scale developed by David Peryam and colleagues at the Quartermaster Food and Container Institute of the U.S. Armed Forces. The 9-Point Hedonic Scale includes successive integer values ranging from 1 to 9, each integer value being associated with a verbal anchor that is different from every other verbal anchor. The 9-Point Hedonic Scale includes the following integers and verbal anchors: 1—Dislike Extremely; 2—Dislike Very Much; 3—Dislike Moderately; 4—Dislike Slightly; 5—Neither Like Nor Dislike; 6—Like Slightly; 7—Like Moderately; 8—Like Very Much; and 9—Like Extremely.

As used in this disclosure and the appended claims, the singular forms “a,” “an” and “the” include plural referents unless the context clearly dictates otherwise.

As used herein, “about” is understood to refer to numbers in a range of numerals. Moreover, all numerical ranges herein should be understood to include all integer, whole or fractions, within the range.

As used herein, “adult-liking” refers to an adult's liking or disliking of a consumable product according to a product rating scale such as, for example, the 9-Point Hedonic Scale. For example, if an adult finds a consumable product to be delicious, the adult may indicate a liking of the product as Like Extremely (e.g., scale rating of a 9), or Like Very Much (e.g., scale rating of 8). The skilled artisan will appreciate, however, that adult-liking need not be measured only by the 9-Point Hedonic Scale and may be measured using any rating scale known in the art.

As used herein, “child-liking” refers to a child's liking or disliking, or preference for, a consumable product. Child-liking is commonly interpreted or evaluated by parents and/or trained evaluators after administration of a consumable product to the child. Child-liking may also be evaluated as a direct behavior exhibited by a child. Such direct behavior may include, for example, consumption of more of one food product over another, pointing to foods that the child prefers to consume, specifically reaching for one food product instead of another, etc.

As used herein, “pre-schoolers” or “pre-school-aged children” refer to children in the age range from about 24 months to about 42 months (e.g., about 2 to about 3.5 years of age).

Because the market for children's foods is continuously growing and expanding, and because children have an increasing influence on food purchase decisions made by parents, children are increasingly being used in product development by food manufacturers. Child-liking of a product is critical for success of the product on the market. Indeed, a parent is much more likely to purchase a specific product if the parent knows that the product is well-liked or well-accepted by the child. Thus, it is important for companies providing foods for children to understand their needs and wants with respect to foods.

Certain age groups, however, present a challenge with respect to sensory and consumer research testing because of their developmental stage and/or communication skills. For example, product-liking among pre-verbal children is particularly difficult to assess because of their inability to communicate verbally. Taste and olfactory responses of newborns and infants have previously been assessed by studying hedonically-motivated characteristics such as, for example, facial expressions, respiration, heart rate, sucking patterns, differential ingestion, and autonomic reactivity. The responses may also be measured by studying, for example, lateral tongue movements.

One example of a method to test acceptance (e.g., like/dislike) of consumable products by pre-verbal children to guide product development for child targeted products (e.g., baby food) in a product testing context includes the use of scale-based responses such as a child-liking scores based on a subjective interpretation of the child's responses to products. These types of testing methods, which are typically implemented by parents, have been used almost exclusively in the past because pre-verbal children cannot read, write, or use words to described their liking or disliking of particular food product. In contrast, parents must rely on the facial and bodily expression of such children to determine the liking and/or wanting of a specific food product. Child-liking, as historically assessed by parents, therefore, is often not very differentiating across multiple products (e.g., mean scores were similar and less significantly different). As a result, decisions to guide product development are often made based solely on adult opinions or preferences.

The 9-Point Hedonic Scale developed by David Peryam and colleagues is one example of such a scale-based approach and was quickly adopted by the food, personal care, household products and cosmetic industries. The 9-Point Hedonic Scale includes verbal anchors that were selected so that the psychological distance between successive scale points is approximately equal. The equal-interval property helps to justify the practice of analyzing the responses by assigning successive integer values to the scale points and testing differences in average acceptability using parametric statistics. The verbal anchors associated with the 9-Point Hedonic Scale include Like Extremely, Like Very Much, Like Moderately, Like Slightly, Neither Like nor Dislike, Dislike Slightly, Dislike Moderately, Dislike Very Much, and Dislike Extremely. The integer values assigned to each of these verbal anchors range from 9 down to 1, respectively. The 9-Point Hedonic Scale is set forth below at Table 1.

TABLE 1
9-Point Hedonic Scale

| | |
|---|---|
| 9 | Like Extremely |
| 8 | Like Very Much |
| 7 | Like Moderately |
| 6 | Like Slightly |
| 5 | Neither Like nor Dislike |
| 4 | Dislike Slightly |
| 3 | Dislike Moderately |
| 2 | Dislike Very Much |
| 1 | Dislike Extremely |

Additionally, behavioral observation techniques such as facial coding by expert observers to interpret child-liking of pre-verbal children during product development testing are also available for use. These techniques, however, are typically applied in a more academic setting and the results are cumbersome to collect and utilize to guide product development in the fast-paced product testing environment of the consumer goods industry.

Similar to pre-verbal children, interpretation of child-liking among pre-school-aged children (e.g., 24 months to 42 months) during product development can also be challenging since known methods employ indirect means by which to obtain child-liking results (e.g., subjective interpretation by parents after product administration). In this regard, parents are still able to influence child-liking results during product testing.

One attempt to mitigate parental influence of child-liking scores was a scale-based extension of the 9-Point Hedonic Scale developed, in part, by B. J. Kroll in 1990, which showed that a scale with nine “child friendly” verbal anchors ranging from “super good” to “super bad” performed better with 5-10 year old children than did the 9-Point Hedonic Scale or a scale utilizing “smiley” faces. Such a scale, however, is not as reliable as the 9-Point Hedonic Scale when dealing with children younger than this age group. Additionally, Applicant has found that use of a neutral indicator (e.g., “neither good nor bad”) is a difficult assessment tool for a pre-school aged child to properly utilize.

In response to such inefficient or cumbersome product development testing models, Applicant has created practically applicable methods for obtaining direct child-liking scores for pre-schoolers in a product testing environment to better aid in development of products to delight the child consumer. Indeed, Applicants has developed methods to help understand the drivers of child-liking scores, and to identify strategies to obtain direct child-liking data without increasing sample size.

Generally speaking, Applicant has developed three different approaches to measuring liking or preference among pre-schoolers in a format suitable for evaluation by parents. The three approaches include a scale-based approach, a consumption-based approach, and a preference approach. Use of the approaches yields direct information regarding child-liking scores and are especially useful for children aged 24-42 months. The approaches can be applied across multiple products and/or prototypes to compare relative child acceptance.

In the literature, and as discussed briefly above, modified scaling approaches using kid-friendly wording such as, for example, “super-good” or “super bad” and pictorial scales including smiley face scales have been used with kids at various ages starting as young as three years of age. These approaches, however, have shown limited success that increases with advancing age and development of cognitive skills. One of the main reasons for the lack of success with using these types of approaches is the highly variable cognitive and language skills of the children in the age group being tested. Another reason for lack of success with, for example, a 5-point rating scale, is that the use of a “neutral” point is a difficult concept for children of young ages to understand and properly utilize in a product testing environment.

In an embodiment, the methods of the present disclosure include the use of a 4-point, bifurcated scale-based approach having an embedded step-wise 2-component approach. More specifically, the present scale-based approach removes the center description from a typical 5-point scale, which is usually a “neutral” scale point, because Applicant has determined that use of such a scale point is difficult for young children to understand and properly utilize. As such, the incorporation of such a neutral scale point lessens the value and integrity of the scale being used to assess child-liking and preference.

Instead, the present scale-based approach begins with an initial inquiry as to the general liking of the food by the child. In this regard, a child may initially be confronted with a 2-component approach in which the child is asked whether a tested food product is either (1) positively accepted or (2) negatively accepted. The positive acceptance of the food may be identified using a positive description of the food product. Examples of such positive descriptions include, but are not limited to, yummy, good, tasty, delicious, scrumptious, etc. The negative acceptance of the food may be identified using a negative description of the food product. Examples of such negative descriptions include, but are not limited to, yucky, bad, icky, gross, etc. The skilled artisan will appreciate that any such positive and/or negative descriptors may be used. However, in an embodiment, the positive and/or negative descriptors used may be positive and/or negative descriptors typically used by small children (e.g., yummy, yucky, icky, etc.).

Once the child has identified the tested food product as either (1) positively accepted or (2) negatively accepted, the 4-point, bifurcated analysis continues with the child being asked or instructed to further analyze the food product by modifying the child's initial description of the food (e.g., yummy, yucky, etc.). For example, if the child initially provides a positive acceptance of the food product using a positive descriptor of “yummy,” the child may then be asked whether the food product was “yummy,” or “super yummy.” In this respect, the initial descriptor of “yummy” may be modified by the child as “super yummy” if the child really likes the food product. Examples of modifying words, or modifiers, include, but are not limited to super, extra, really, more, very, etc. The skilled artisan will appreciate that any such modifier may be used. However, in an embodiment, the modifier used may be a modifier typically used by small children (e.g., super, really, etc.).

The scale-based approach described above may be especially useful in comparing two or more different products with respect to child-liking. In this regard, the present scale-based approach may be employed to analyze child-liking of a first product, and then employed to analyze child-liking of a second product. Such an analysis may be performed in a sequential monadic presentation (i.e., one product at a time). Due to the ease of administration and the accuracy of the direct results, the results from each administration can be easily utilized to determine which of the two products is preferred by the child. Accordingly, Applicant has developed a 4-point bifurcated scale-based approach with a 2-component initial analysis that is able to provide a simplified manner in which direct results of child-liking in pre-schoolers can be obtained in a product testing environment.

In an embodiment, the scale-based approach may be combined with a preceding scale practice component, or scale training piece. The scale training piece may be an initial practice with the scale, which provides a reliable and practical method to assess product acceptance among pre-schoolers to help support their growing independence and to help articulate the voice of the child who is ultimately the target consumer. For example, prior to product testing, a child may be shown a print-out, board, photograph, slide, etc., containing pictures of a variety of food products that children would typically find either appealing (e.g., an apple) or unappealing (e.g., broccoli). The children may then be asked to identify which products the child finds appealing using a positive descriptor (e.g., yummy) or unappealing using a negative descriptor (e.g., yucky). Upon identification of yummy and yucky products, the child may then be asked to identify each positively accepted product as either yummy or super yummy. Similarly, the child may also be asked to identify each negatively accepted product as either yucky or super yucky. Use of such a scale practice component allows the child to visualize, name and categorize the different foods, which jump starts the child's cognitive, language and judgment skills prior to the product testing.

Accordingly, the 4-point, bifurcated scale-based approach combined with a preceding scale practice provides for a simplified task through the use of a common foods image chart for scale familiarization to help with visualization and naming of liked and disliked foods by asking the child to only judge preference. The 4-point, bifurcated scale-based approach combined with a preceding scale practice also provides for a simplified scale through the use of more age-appropriate analysis (as compared to known child-liking scales) to help with the judgment of products as liked or disliked.

The present scale-based approach also provides additional benefits and advantages over known child-liking scales. For example, the present scale-based approach eliminates the cognitively more difficult center/neutral scale point, which provides for a more accurate and less complicated analysis by the child. The present scale-based approach also uses scale terms that are more appropriate to child food assessments (e.g., “yummy” and “yucky”).

A second approach developed by Applicant to measuring liking or preference among pre-schoolers in a format suitable for evaluation by parents is the consumption-based approach. The literature on measuring preference in newborns (e.g., pre-verbal children), and separately the literature on measuring preference in pets, looks at consumption. For example, the pet food industry uses both palatability testing and feeding trials to measure preference in pets. However, consumption and side by side preference have not been explored in the literature with respect to pre-school-aged children.

In the present consumption-based approach, a number of different factors may be analyzed to determine a child's preference for one product over another. In this regard, the products being tested may be presented side-by-side for analysis and consumption of the products are examined as an indicator of preference. Initially, a child may be asked questions to determine whether the child can recognize a visual distinction between two different products being tested. In this regard, a tray with identical bowls of different, covered products maybe set before the child. A test administrator (or parent) may then show the child a print-out, board, photograph, slide, etc., containing pictures of the two different products. The cover of one product may be removed and the child asked to point to the picture of that food product. A similar procedure may be performed with respect to the second food product. This process confirms a child's ability to visually distinguish one food product from another, thereby validating the child's selection of one food product or the other for consumption.

Additionally, the food products being tested may be weighed prior to being set before the child for consumption. The child may be instructed that she can eat as much or as little of the products as she wants until the product is depleted or until a predetermined amount of time expires. Additionally, the child may request additional amounts of a specific product if desired. Once the test is completed, the remaining amounts of food products are weighed to determine which food product was most consumed by the child.

Further, during the period of time in which the child is consuming the food products, the test administrator (or parent) may be asked to record a variety of other factors including, for example, the number of trips from bowl to mouth taken by the child to consume the product, which hand was used to consume which product, how many pieces were typically taken in the hand during each bowl to mouth trip, how many fingers were used during each bowl to mouth trip, etc. Applicant has surprisingly found that each of these different factors can contribute to the overall understanding of child-liking and preference for a specific food product based on consumption of the food product.

A third approach developed by Applicant to measuring liking or preference among pre-schoolers in a format suitable for evaluation by parents is the preference-based approach. In the present preference-based approach, at least two or more food products can be directly compared by a child using sequential paired product presentations having the products presented in different configurations for each presentation.

For example, in a first presentation of two different food products, a first food product may be presented on a tray in the twelve o'clock position (with respect to a clock placed in front of the child), while a second food product is placed in the six o'clock position. In a second presentation, the first food product may be placed in the three o'clock position while the second food product is placed in the nine o'clock position. In a third presentation, the first food product may be placed in the six o'clock position while the second food product is placed in the twelve o'clock position. In a fourth presentation, the first food product may be placed in the nine o'clock position while the second food product is placed in the three o'clock position. The skilled artisan will appreciate that these product placements are merely examples of different product placement configurations and that any configuration may be used to explore preference for a product based on position bias and handedness of a pre-schooler.

During each product presentation, the child may be instructed that she can eat as much or as little of the products as desired. During testing, the test administrator (or parent) may record a number of different factors observed while the child consumes the product. For example, for each product presentation the test administrator may observe which of the different products the child placed in her mouth first, which hand the child used to consume which product, whether the child tried both food products or neither food product, etc. The test administrator may also directly ask the child which food product the child preferred.

Accordingly, Applicant has developed a preference-based approach that aids in exploring a child's preference for a product based on position bias and handedness. However, such a preference-based approach could also be adapted and applied to situations where a child judgment task is desired (e.g., to determine child preference for other consumer durables or non-durable goods, etc.).

With respect to each of the three different approaches described herein above, Applicant surprisingly found that the scale-based and consumption-based approaches both provided highly useful results, with scale use being the more practical of the two. The scale-based approach provides a 4-point, 2-component (bifurcated) scale that has been found to be more appropriate to food assessment with young children. As discussed above, the scale-based approach may also include a scale training piece involving initial practice with the scale, which provides a reliable and practical method to assess product acceptance among pre-schoolers to help support their growing independence and to help articulate the voice of the child who is ultimately the target consumer.

The skilled artisan will appreciate that the results and/or observations obtained from use of any of the approaches described above may be recorded using appropriate means including, for example, written questionnaires, processing devices (e.g., computers, hand-held processing devices, or the like), etc. In an embodiment, the results and/or observations described herein above are recorded using written questionnaires and the results are later entered into a processing device so that a database of product development information can be formed. This will allow Applicant to quickly and easily interpret and manipulate data from a single product testing event, or large amounts product testing data acquired from several product testing events.

In an embodiment, a method for assessing child-liking of a food product is provided. The method includes providing a food product to a child, instructing the child to consume the food product, asking the child, after the child consumes the food product, to classify the food product using either a positive descriptor or a negative descriptor, asking the child, if the child classified the food product using a positive descriptor, to further classify the food product using the positive descriptor or a modified positive descriptor, and asking the child, if the child classified the food product using a negative descriptor, to further classify the food product using the negative descriptor or a modified negative descriptor. The method helps to assess child-liking and preference of a food product by obtaining direct, simple, and accurate measures of a child's liking that does not require subject parental interpretation.

In another embodiment, a method for improving product development is provided. The method includes providing a food product to a child, instructing the child to consume the food product, asking the child, after the child consumes the food product, to classify the food product using either a positive descriptor or a negative descriptor, asking the child, if the child classified the food product using a positive descriptor, to further classify the food product using the positive descriptor or a modified positive descriptor, and asking the child, if the child classified the food product using a negative descriptor, to further classify the food product using the negative descriptor or a modified negative descriptor. The method helps to improve product development because product developers are able to modify, change or reformulate products in view of information obtained from the child with respect to product liking and/or preference. In this regard, a product prototype may be completely reformulated if a child describes the product as “super yucky.” Alternatively, a product prototype may be ready for market if a child describes the product as “super yummy.”

In yet another embodiment, a method for improving product development is provided. The method includes providing a food product to a child, instructing the child to consume the food product, instructing the child, after the child consumes the food product, to classify the food product using either a positive descriptor or a negative descriptor, instructing the child, if the child classified the food product using a positive descriptor, to further classify the food product using the positive descriptor or a modified positive descriptor, and instructing the child, if the child classified the food product using a negative descriptor, to further classify the food product using the negative descriptor or a modified negative descriptor. The method helps to improve product development because product developers are able to modify, change or reformulate products in view of information obtained from the child with respect to product liking and/or preference. In this regard, a product prototype may be completely reformulated if a child describes the product as “super yucky.” Alternatively, a product prototype may be ready for market if a child describes the product as “super yummy.”

In still yet another embodiment, a method for developing a new consumable product is provided. The method includes providing a food product to a child, instructing the child to consume the food product, instructing the child, after the child consumes the food product, to classify the food product using either a positive descriptor or a negative descriptor, instructing the child, if the child classified the food product using a positive descriptor, to further classify the food product using the positive descriptor or a modified positive descriptor, and instructing the child, if the child classified the food product using a negative descriptor, to further classify the food product using the negative descriptor or a modified negative descriptor. The method helps to develop new products because product developers are able to modify, change or reformulate products in view of information obtained from the child with respect to product liking and/or preference. In this regard, a product prototype may be completely reformulated if a child describes the product as “super yucky.” Alternatively, a product prototype may be ready for market if a child describes the product as “super yummy.”

In another embodiment, a method for improving marketing of a consumable product is provided. The method includes providing a food product to a child, instructing the child to consume the food product, instructing the child, after the child consumes the food product, to classify the food product using either a positive descriptor or a negative descriptor, instructing the child, if the child classified the food product using a positive descriptor, to further classify the food product using the positive descriptor or a modified positive descriptor, and instructing the child, if the child classified the food product using a negative descriptor, to further classify the food product using the negative descriptor or a modified negative descriptor. The methods are able to aid in improving marketing of a product because product testers will be able to determine in advance whether children find the product to be organoleptically pleasing or displeasing.

In yet another embodiment, a method for predicting market success of a food product is provided. The method includes providing a food product to a child, instructing the child to consume the food product, instructing the child, after the child consumes the food product, to classify the food product using either a positive descriptor or a negative descriptor, instructing the child, if the child classified the food product using a positive descriptor, to further classify the food product using the positive descriptor or a modified positive descriptor, and instructing the child, if the child classified the food product using a negative descriptor, to further classify the food product using the negative descriptor or a modified negative descriptor. The methods are able to aid in predicting market success of a product because product testers will be able to determine in advance whether children find the product to be organoleptically pleasing or displeasing.

By way of example and not limitation, the following examples are illustrative of various embodiments of the present disclosure.

### EXAMPLES

As discussed above, Applicant has developed three different approaches to measure liking or preference among pre-school-aged children in a format suitable for evaluation by parents. The three different approaches include the scale-based approach, a consumption approach, and a preference approach, as discussed generally above. The following examples set forth specific testing completed by Applicant using each of the three different approaches. The skilled artisan will appreciate, however, that the examples set forth below are not limiting and that the tools and methods used therein may be modified or altered without departing from the spirit and scope of the present subject matter and without diminishing its intended advantages.

Although each of the different approaches below are described as separate examples, and can be deployed on an individual basis, Applicant administered each of the three approaches to the same children on three separate occasions. The children who participated in the study were divided into three different age groups having approximately 50 children in each age group, which included (i) 24-29 months; (ii) 30-35 months; and (iii) 36-42 months.

Each of the administered approaches described below included the use of two food products: (i) star-shaped cereal puffs manufactured by Applicant; and (ii) “o”-shaped cereal products manufactured by another manufacturer. Depending on the approach being evaluated, the cereal products were presented in a sequential monadic product presentation (i.e., one product at a time), a sequential paired product presentation (i.e., two products at a time, one of each product), or a paired product presentation (i.e., two products side-by-side, one of each product). The products were always presented as one product in a bowl and the same types of bowls were used for the product presentation.

Prior to product testing, and at the beginning of each approach described below, Applicant asked parents to evaluate their child's general mood/state that day, which included questions pertaining to the foods and drinks the child consumed that day, naps the child took that day and general observations including, for example, happy/sad, hungry/full, sleepy/awake, etc.

### Example 1

### Scale-Based Approach

To explore the validity of a scale-based approach, Applicant performed food product tests with pre-school-aged children using a 4-point, bifurcated scale. As described above, the 4-point, bifurcated scale included the use of positive food descriptors, negative food descriptors, modified positive food descriptors, and modified negative food descriptors, as will be described below. The two different food products (e.g., star-shaped puffs and “o”-shaped products) were presented in a sequential monadic presentation.

To prepare the children for product evaluation, parents were given a board printed with pictures of various foods that a child may find appealing (e.g., “yummy”) or unappealing (e.g., “yucky”). Practice of this 2-point scale allowed the child to visualize, name and categorize the different types of foods in front of her. After identification of different yummy or yucky foods, the child was then asked to assign a degree of “yumminess” or “yuckiness” to the foods selected (e.g., to modify the positive or negative descriptors). For example, if a child selected broccoli as a yucky food, the child was asked a question such as, for example, “is the broccoli yucky or super yucky”? Practice of this 4-point scale allowed the child to practice evaluation of the degree to which the child liked or did not like a specific food.

After practicing with pictures of various foods, the children were asked to evaluate the two sample food products in a sequent monadic product presentation. The children were presented with a first food product and asked whether the food product was yummy or yucky. Depending on the child's initial response, the child was then asked to modify his or her response. For example, if the child answered that the product was yummy, the parent then asked the child if the product was yummy or super yummy. Alternatively, if the child answered that the product was yucky, the parent then asked the child if the product was yucky or super yucky. This process was then repeated for the second food product.

During the testing, the parents were asked to evaluate their level of confidence in the accuracy of the child's responses, and to indicate an overall reaction to the product using a 9-point hedonic scale.

Applicant surprisingly found that over 93% of the children tested were able to respond using a 2-point scale (e.g., identifying products as yummy or yucky). Applicant also surprisingly found that about 83% of children were able to response using a 4-point bifurcated scale (e.g., identifying products as super yummy, yummy, yucky, or super yucky). Specifically, about 66% of children aged 24-29 months were able to respond, about 85% of children aged 30-35 months were able to respond, and about 97% of children aged 36-42 months were able to respond. Based on the results obtained, Applicant was able to determine that the star-shaped puff food product rated significantly higher than the “o”-shaped food product among children aged 24-35 months, and at parity among children aged 36-42 months.

Accordingly, Applicant surprisingly found that 4-point, bifurcated scale provided a highly successful means by which to directly determine child-liking of a food product by a pre-school-aged child during product development and testing.

### Example 2

### Consumption-Based Approach

To explore the validity of a consumption-based approach, Applicant performed food product tests with pre-school-aged children using perceived visual differences of food products, pre- and post-weights of a product after consumption, and the number and types of trips to the child's mouth during consumption. For the consumption-based approach, the two different food products (e.g., star-shaped puffs and “o”-shaped products) were presented in a paired product presentation to examine consumption as an indicator of preference.

To prepare the children for product evaluation, a tray having two covered bowls (each bowl containing one of the different food products) was set in front of the child. Parents were given a board printed with pictures of each of the different food products and were instructed to remove the cover of a first food product. The parents then asked the children to identify the picture that looked like the uncovered food product. The same task was performed with the second food product. This exercise used referential understanding to confirm the child's perceived visual differences between the first and second food products.

After practicing with pictures of the two food products, covers for both food products were removed and the children were allowed to eat as much or as little of each food product as desired for as long as they preferred, or within 10 minutes. The same amount of product was included in each bowl. During the testing time, parents were asked to record the amount of time the child took to consume the product, which hand the child consumed each product with, how many times the child's hand went to the mouth, and about how many pieces of each food product were consumed during each trip from bowl to mouth. After testing, both bowls were weighed to determine how much of each product the child consumed.

During the testing, the parents were asked to evaluate different behaviors of the child during product consumption, and to indicate their impression of their child's an overall reaction to the product using a 9-point hedonic scale.

Applicant surprisingly found that approximately 45% of the star-shaped puffs were consumed by weight, as compared to about 10% of the “o”-shaped product, within a 10 minute time period when presented side-by-side. Applicant also surprisingly found that the average number of trips to mouth were recorded at about 29 for the star-shaped puffs, as compared to about 12 for the “o”-shaped product. About 82% of the children tested were able to accurately match the picture of the different food products to the food products themselves. More specifically, about 70% of the children aged 24-29 months were able to match the photos to the products, about 82% of the children aged 30-35 months were able to match the photos to the products, and about 95% of the children aged 36-42 months were able to match the photos to the products.

Accordingly, Applicant surprisingly found that consumption-based approach provided a highly successful means by which to directly determine child-liking of a food product by a pre-school-aged child during product development and testing.

### Example 3

### Preference-Based Approach

To explore the validity of a preference-based approach, Applicant performed food product tests with pre-school-aged children using different orientations of paired product presentations. Specifically, the two different food products (e.g., star-shaped puffs and “o”-shaped products) were presented in four different, sequential paired product presentations to examine the effects of position bias and handedness of a child with respect to preference.

In a first paired presentation, for example, a tray was presented to the child having a bowl of the star-shaped puff product located at twelve o'clock and a bowl of the “o”-shaped product located at six o'clock. In a second paired presentation, for example, a tray was presented to the child having a bowl of the star-shaped puff product located at nine o'clock and a bowl of the “o”-shaped product located at three o'clock. In a third paired presentation, for example, a tray was presented to the child having a bowl of the star-shaped puff product located at six o'clock and a bowl of the “o”-shaped product located at twelve o'clock. In a fourth paired presentation, for example, a tray was presented to the child having a bowl of the star-shaped puff product located at three o'clock and a bowl of the “o”-shaped product located at nine o'clock.

During product testing, the child was instructed to consume as much or as little of each product presented on the tray, and the trays were presented sequentially to the child. For each tray, the parents were asked to note which sample was consumed first by the child and which hand the child used to consume the product. After each tray, the child was asked to identify which product was preferred.

During the testing, the parents were asked to evaluate their level of confidence in the accuracy of the child's responses.

Applicant surprisingly found a strong interaction between handedness of the child and presentation of the food products. Specifically, for the tray having a bowl of the star-shaped puff product located at twelve o'clock and a bowl of the “o”-shaped product located at six o'clock, about 61% of children preferred the star-shaped puffs when compared to 84% of children who preferred the star-shaped puffs on the tray having the star-shaped puff product located at six o'clock and a bowl of the “o”-shaped product located at twelve o'clock. With both of these tray presentations, the children seemed to use both hands about equally to consume the product.

Similarly, for the tray having a bowl of the star-shaped puff product located at nine o'clock and a bowl of the “o”-shaped product located at three o'clock, about 92% of children used their left hand to consume the product (e.g., the hand nearer the star-shaped product), while about 62% of children used their right hand. For the tray having a bowl of the star-shaped puff product located at three o'clock and a bowl of the “o”-shaped product located at nine o'clock, about 83% of children used their right hand to consume the product (e.g., the hand nearer the star-shaped product), while about 46% of children used their left hand. With both of these tray presentations, the children seemed to about equally prefer (about 74%) the star-shaped puffs over the “o”-shaped product.

Accordingly, Applicant surprisingly found that a preference-based approach provided a less stable means by which to directly determine child-liking of a food product by a pre-school-aged child during product development and testing. In this regard, the strong interaction between handedness and presentation of the products implies that the child's choices had less to do with the product choices and more to do with the presentation of the products.

As such, using the methods of the present disclosure, Applicant was able to obtain direct child-liking scores of specific food products being tested by pre-school-aged children. In view of the direct results obtained, the methods of the present disclosure will improve the efficiency and effectiveness of product testing, and will provide for improved product development.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method for assessing child-liking of a food product, the method comprising:
providing a food product to a child;
instructing the child to consume the food product;
asking the child, after the child consumes the food product, to classify the food product using either a positive descriptor or a negative descriptor;
asking the child, if the child classified the food product using a positive descriptor, to further classify the food product using the positive descriptor or a modified positive descriptor;
asking the child, if the child classified the food product using a negative descriptor, to further classify the food product using the negative descriptor or a modified negative descriptor; and
recording the classifications provided by the child, wherein the classifications are recorded by a means selected from the group consisting of a written questionnaire, a processing device, and combinations thereof.

2. The method according to claim 1, wherein the child is from about 24 months to about 42 months of age.

3. The method according to claim 1, wherein the child is a pre-school-aged child.

4. The method according to claim 1, wherein the food product is formulated for consumption by a child.

5. The method according to claim 1, further comprising showing the child pictures of a variety of foods and asking the child to identify each of the foods in the pictures with a positive or negative indicator.

6. The method according to claim 1, further comprising showing the child a picture of the food product next to a picture of a second food product, placing the first food product in front of the child, and asking the child to point to the picture of the first food product.

7. The method according to claim 1, further comprising showing the child a picture of the food product next to a picture of a second food product, placing the second food product in front of the child, and asking the child to point to the picture of the second food product.

8. The method according to claim 1, further comprising providing at least one subsequent food product to a child;
instructing the child to consume the at least one subsequent food product;
asking the child to classify the at least one subsequent food product using either a positive descriptor or a negative descriptor;
asking the child, if the child classified the at least one subsequent food product using a positive descriptor, to further classify the food product using the positive descriptor or a modified positive descriptor;
asking the child, if the child classified the at least one subsequent food product using a negative descriptor, to further classify the food product using the negative descriptor or a modified negative descriptor, wherein the positive descriptor comprises a positive descriptor commonly associated with children of an age ranging from about 24 months to about 42 months, and the negative descriptor comprises a negative descriptor commonly associated with children of an age ranging from about 24 months to about 42 months.

9. The method according to claim 1, wherein the positive descriptor is selected from the group consisting of yummy, good, tasty, delicious, scrumptious, and combinations thereof.

10. The method according to claim 9, wherein the positive descriptor is yummy.

11. The method according to claim 1, wherein the negative descriptor is selected from the group consisting of yucky, bad, icky, gross, and combinations thereof.

12. The method according to claim 11, wherein the positive descriptor is yucky.

13. The method according to claim 1, wherein the modified positive descriptor comprises the positive descriptor and a modifier, the modifier commonly associated with children of an age ranging from about 24 months to about 42 months, the modified negative descriptor comprises the negative descriptor and a modifier, the modifier commonly associated with children of an age ranging from about 24 months to about 42 months, and combinations thereof.

14. The method according to claim 13, wherein the modifier is selected from the group consisting of super, extra, really, more, very, and combinations thereof.

15. A method for improving product development, the method comprising:
the method for assessing child-liking of a food product formulated for consumption by a child, selected from the group consisting of those claimed in claim 1 to claim 14.

16. The method according to claim 15, wherein a new consumable product is developed.

17. The method according to claim 15, wherein an improved consumable product is developed.

18. The method according to claim 15, further comprising the step of modifying the food product to improve liking.

19. A method for improving marketing of a consumable product, the method comprising:
the method for assessing child-liking of a food product formulated for consumption by a child, selected from the group consisting of those claimed in claim 1 to claim 12.

20. The method according to claim 15, wherein market success of a food product is predicted.
